(19) United States
(12) Patent Application Publication
(10) Pub. No.: US 2025/0323323 A1
(43) Pub. Date: Oct. 16, 2025

(54) MIXED ELECTROLYTE FOR RECHARGEABLE BATTERY

(71) Applicant: THE REGENTS OF THE UNIVERSITY OF CALIFORNIA, Oakland, CA (US)

(72) Inventor: Gao LIU, Piedmont, CA (US)

(21) Appl. No.: 19/177,038

(22) Filed: Apr. 11, 2025

Related U.S. Application Data
(60) Provisional application No. 63/633,281, filed on Apr. 12, 2024.

(51) Int. Cl. H01M 10/0569; H01M 10/0525; H01M 10/054; H01M 10/0568

(52) U.S. Cl. CPC H01M 10/0569; H01M 10/0525; H01M 10/054; H01M 10/0568; H01M 2300/0042

(57) ABSTRACT

The present invention provides for an electrolyte composition comprising a hydrocarbon solvent. The present invention provides for a lithium- or sodium-based battery comprising the electrolyte composition of the present invention.

### CROSS REFERENCE TO RELATED APPLICATIONS

This application claims priority to U.S. Provisional Patent Application Ser. No. 63/633,281, filed Apr. 12, 2024, which is incorporated by reference in its entirety.

### STATEMENT OF GOVERNMENTAL SUPPORT

The invention was made with government support under Contract No. DE-AC02-05CH11231 awarded by the U.S. Department of Energy. The government has certain rights in the invention. μ

### FIELD OF THE INVENTION

This invention relates generally to rechargeable batteries.

### BACKGROUND OF THE INVENTION

The growing need for electric and hybrid vehicles, as well as stationary energy storage solutions, is driving the demand for advanced battery technologies that surpass the capabilities of current lithium-ion batteries (LIBs). Lithium-sulfur batteries (LSBs) are emerging as a promising alternative to LIBs due to their exceptionally high theoretical capacity (1672 mA h/g) and energy densities (2600 Wh/kg). Furthermore, while this higher energy density marks a substantial advancement, with values 3-5 times greater than conventional LIBs, there are still significant hurdles to overcome before widespread commercialization, unlike LIBs. Despite extensive research efforts focusing on various aspects such as sulfur cathode development, Li-metal anode improvement, separator modification, intercalated layer configurations within the cell, and electrolyte design, the persistent challenge of the polysulfide shuttling effect remains unresolved. The electrochemical reaction involving sulfur necessitates innovative electrolytes to replace traditional carbonate-based systems inherited from LIBs. Carbonates pose compatibility issues with the intermediate polysulfides in LSBs. Moreover, achieving the theoretical specific capacities and projected energy densities of LSBs proves challenging in practice. This difficulty arises primarily from the electronically insulating nature of sulfur and lithium sulfide cathodes, compounded by the shuttle effect. The shuttle effect involves the dissolution and diffusion of soluble polysulfides in many potential electrolytes, leading to rapid capacity degradation. Therefore, there is a pressing need to explore, modify, and optimize electrolytes for LSBs. Such efforts aim to address these issues and enhance the batteries' capacities, cycling stabilities, rate performances, and energy densities.

To date, numerous studies have focused on liquid electrolytes to enhance the capacities and capacity retentions of LSBs. However, achieving compatibility with lithium metal in terms of both chemical and electrochemical reactions is crucial for the successful operation of LSBs. Consequently, many researchers have opted for ether solvents combined with lithium bis(trifluoromethanesulfonyl)imide (LiTFSI) and lithium bis(fluorosulfonyl)imide (LiFSI) salts. These choices are motivated by the desirable properties of ether solvents, including low volatility, low flammability, and low toxicity. Additionally, LiTFSI and LiFSI salts demonstrate robust thermal stability, good dissociation ability, high ionic conductivity, and compatibility with both ether solvents and lithium polysulfides.

### SUMMARY OF INVENTION

The present invention provides for an electrolyte composition comprising a hydrocarbon solvent. The present invention provides for a lithium- or sodium-based battery comprising the electrolyte composition of the present invention.

In some embodiments, the hydrocarbon solvent is an alkane. In some embodiments, the hydrocarbon solvent is a 2, 3, 4, 5, 6, 7, 8, 9, or 10 carbon alkane, or a mixture thereof. In some embodiments, the hydrocarbon solvent is a 5 to 7 carbon alkane, or a mixture thereof. In some embodiments, the hydrocarbon solvent is a branched or straight chained alkane, or a mixture thereof. In some embodiments, the hydrocarbon solvent is a cyclic alkane. In some embodiments, the hydrocarbon solvent is n-heptane, n-hexane, n-pentane, cyclohexane, cyclopentane, cycloheptane, or isomer thereof, or a mixture thereof.

In some embodiments, the electrolyte composition further comprises an ether solvent, an amphiphilic molecule, an electrolyte solvent, and/or a lithium salt or sodium salt, or a mixture thereof. In some embodiments, the electrolyte composition comprises components or compounds described in U.S. Patent Application Publication No. 2023/0231200, hereby incorporated by reference in its entirety. In some embodiments, the amphiphilic molecule is one described in U.S. Patent Application Publication No. 2023/0231200.

In some embodiments, the electrolyte composition comprises ether solvent. In some embodiments, the ether solvent comprises an ether solvent molecule comprising an ether functional group, a carbonate functional group, or an ester functional group, or any mixture thereof. In some embodiments, the ether solvent molecule is linear or cyclic. In some embodiments, the ether solvent molecule comprises a plurality of ether functional groups, carbonate functional groups, or ester functional groups, or any mixture thereof. In some embodiments, the ether solvent molecule comprises 1, 2, 3, or 4 ether, carbonate or ester functional groups. In some embodiments, the ether solvent molecule comprises 1, 2, 3, 4, 5, 6, 7, 8, 9, 10, 11, 12, 13, 14, 15, 16, 17, 18, 19, or 20 carbon atoms. In some embodiments, the ether solvent molecule comprises 1, 2, 3, or 4 ring structures. In some embodiments, each ring structure comprises 1, 2, 3, 4, 5, 6, 7, 8, 9, or 10 carbon atoms. In some embodiments, the ether solvent molecule is a polymer. In some embodiments, the ether solvent molecule is dioxolane (DOL), dimethyl ether (DME), glyme, diglyme, triglyme, tetraglyme, ethylene carbonate (EC), diethyl carbonate (DEC), ethyl methyl carbonate (EMC), dimethyl carbonate (DMC), propylene carbonate (PC), or a mixture thereof.

In some embodiments, the ether solvent molecule is any one of the following molecules:

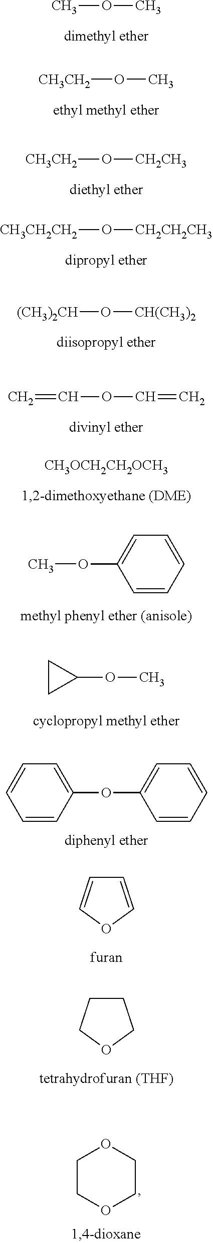

or a mixture thereof.

In some embodiments, the ether solvent molecule is a cyclic ether having any one of the following structures:

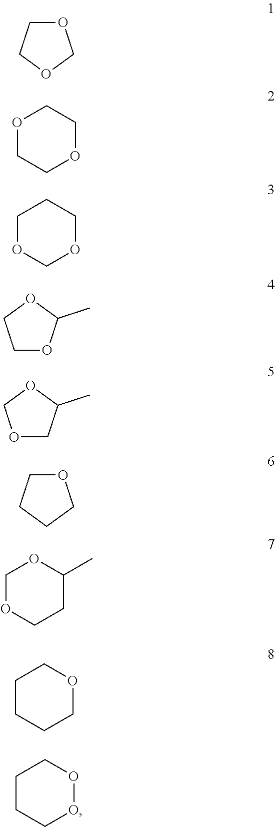

or a mixture thereof.

In some embodiments, the ether solvent molecule is a cyclic carbonate having any one of the following structures:

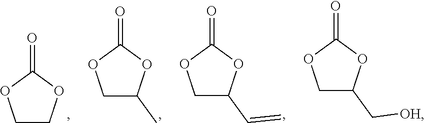

or a mixture thereof. In some embodiments, the ether solvent molecule is a cyclic carbonate having the following structure:

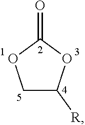

wherein R is an —H, alkyl or alkenyl group, optionally comprising one or more hydroxyl groups. In some embodiments, R comprises a total of 1, 2, 3, 4, 5, 6, 7, 8, 9, or 10 carbon atoms. In some embodiments, R comprises a main chain comprising 2, 3, 4, 5, 6, 7, 8, 9, or 10 carbon atoms. In some embodiments, R is straight chain or branched alkyl group. In some embodiments, R comprises a cycloalkyl ring. In some embodiments, R comprises 1, 2, 3, 4, 5, 6, 7, 8, 9, or 10 hydroxyl groups. In some embodiments, R comprises 1, 2, 3, 4, 5, 6, 7, 8, 9, or 9 C—C double bonds. In some embodiments, R comprises 1, 2, or 3 carbon atoms, optionally comprising 1 hydroxyl group, and/or one C—C double bond.

In some embodiments, the ether solvent molecule is a cyclic ester having any one of the following structures:

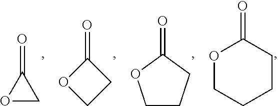

or a mixture thereof.

In some embodiments, the electrolyte composition comprises a lithium salt. In some embodiments, the lithium salt is a lithium bis(oxalato)borate (LiBOB), LiPF6, LiBF4, lithium bis(trifluoromethanesulfonyl)imide (LiTFSI), and/or lithium bis(fluorosulfonyl)imide (LiFSI) salts, or a mixture thereof. In some embodiments, the lithium salt is lithium bis(trifluoromethanesulfonyl)imide (LiTFSI), lithium bis(oxalato)borate (LiBOB), lithium bis(pentafluoroethanesulfonyl)imide (LiBETI), LiClO₄, lithium bis(fluorosulfonyl)imide (LiFSI), LiPF₆, LiAsF₆, or a mixture thereof. In some embodiments, the lithium salt has an ionic association strength that is equal to or less than about the ionic association strength of LiBETI, and is equal to or more than about the ionic association strength of LiTFSI. In some embodiments, the electrolyte composition comprises a lithium salt in/for a lithium-based battery.

In some embodiments, the electrolyte composition comprises a sodium salt. In some embodiments, the electrolyte composition comprises sodium bis(oxalato)borate (NaBOB), NaPF6, NaBF4, sodium bis(trifluoromethanesulfonyl)imide (NaTFSI), and/or sodium bis(fluorosulfonyl)imide (NaFSI), or a mixture thereof. In some embodiments, the sodium salt is sodium bis(trifluoromethanesulfonyl)imide (NaTFSI), sodium bis(oxalato)borate (NaBOB), sodium bis(pentafluoroethanesulfonyl)imide (NaBETI), NaClO₄, sodium bis(fluorosulfonyl)imide (NaFSI), NaPF₆, NaAsF₆, or a mixture thereof. In some embodiments, the electrolyte composition comprises a sodium salt in/for a sodium-based battery.

In some embodiments, the amphiphilic molecule has the following structure:

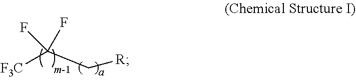

wherein R is

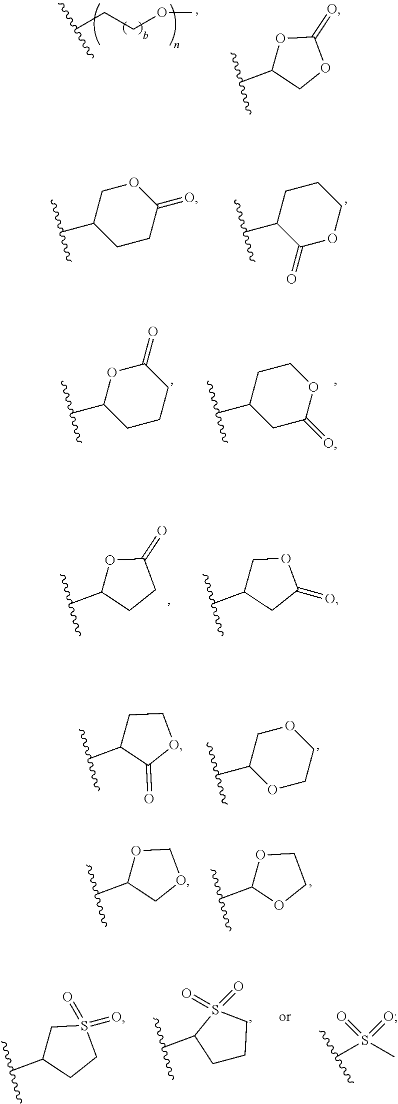

m is an integer from 1 to 21; a is an integer from 0 to 20; b is an integer from 0 to 4; and n is an integer from 1 to 20. In some embodiments, m is 1, 2, 3, 4, 5, 6, 7, 8, 9, 10, 11, 12, 13, 14, 15, 16, 17, 18, 19, 20, or 21. In some embodiments, a is 1, 2, 3, 4, 5, 6, 7, 8, 9, 10, 11, 12, 13, 14, 15, 16, 17, 18, 19, or 20. In some embodiments, b is 0, 1, 2, 3, or 4. In some embodiments, n is 1, 2, 3, 4, 5, 6, 7, 8, 9, 10, 11, 12, 13, 14, 15, 16, 17, 18, 19, or 20.

In some embodiments, the amphiphilic molecule has the following structure:

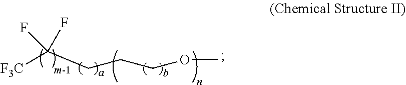

wherein m is an integer from 1 to 21, a is an integer from 0 to 20, b is an integer from 0 to 4, and n is an integer from 1 to 20.

In some embodiments, R is

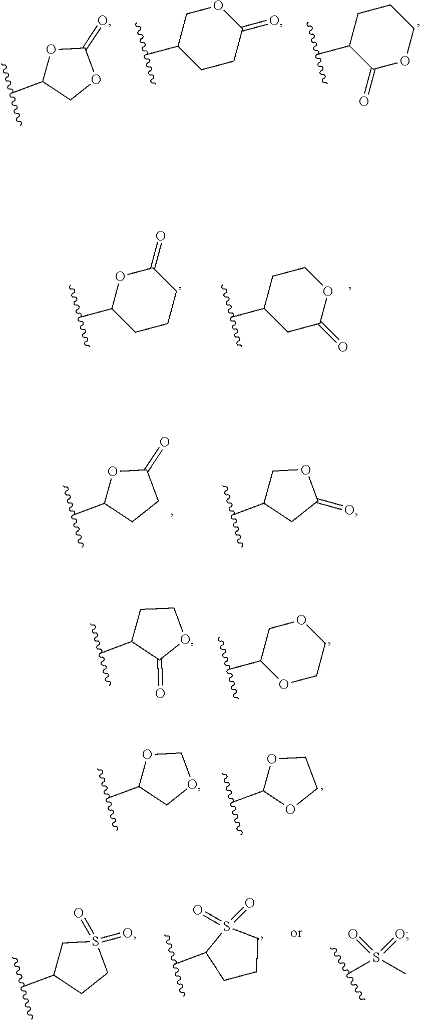

wherein m is an integer from 1 to 21; a is an integer from 0 to 20.

In some embodiments, the amphiphilic molecule has the following structure:

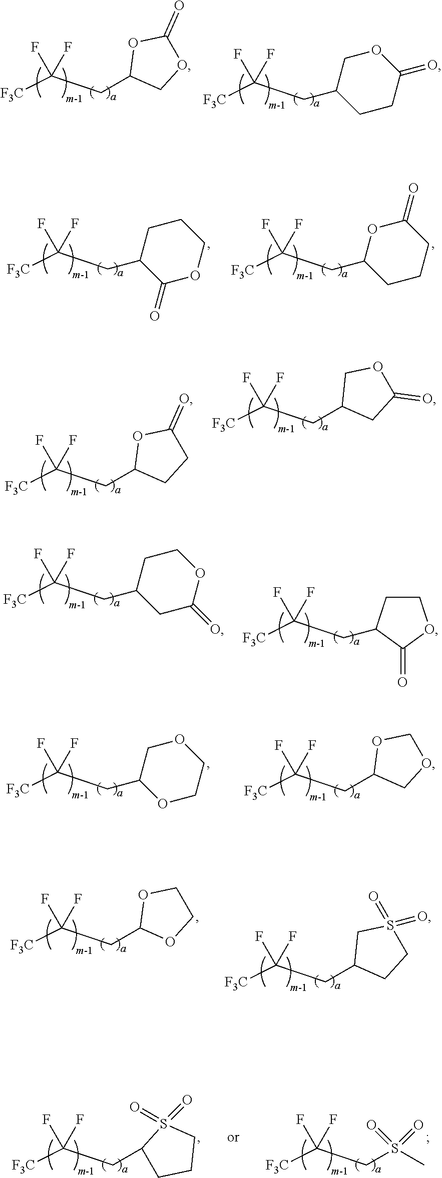

wherein m is an integer from 1 to 21; a is an integer from 0 to 20.

In a particular embodiment, the amphiphilic molecule has Chemical Structure II and is F₃EO₁, wherein m is 3, a is 0, b is 1 and n is 1. In a particular embodiment, the amphiphilic molecule has Chemical Structure II and is F₈EO₄, wherein m is 8, a is 0, b is 1 and n is 4.

In some embodiments, the amphiphilic molecule is capable of self-formation of a micelle. In some embodiments, the micelle is an inverse micelle, prolate micelle, inverse prolate micelle, normal hexagonal phase, inverse hexagonal phase inverse, oblate micelle bilayered fragment, or the like. One skilled in the art can readily identify the polar and non-polar ends (or parts) of each amphiphilic molecule. The fluorinated alkyl is the polar end (or part), while the polyether and R group form the non-polar end (or part).

In some embodiments, the electrolyte solvent is a highly fluorinated alkane, alkyl ether or alkyl tertiary amine comprising more F atoms than H atoms. In some embodiments, the alkane has a main chain having 2, 3, 4, 5, 6, 7, 8, 9, 10, 11, 12, 13, 14, 15, 16, 17, 18, 19, or 20 carbon atoms. In some embodiments, the alkane has a straight or branched chain. In some embodiments, the alkane has a total of 3, 4, 5, 6, 7, 8, 9, 10, 11, 12, 13, 14, 15, 16, 17, 18, 19, or 20 carbon atoms. In some embodiments, the electrolyte solvent has the following chemical structure: R₁—O—R₂, or

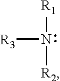

wherein R₁ is —CH₃, —C₂H₅, or —R₄; and R₂, R₃, and R₄ are each independently -α-C_{y}H_{z}F_{2y+1-z}, wherein α is −, —CHF—, —CF₂—, or —CH₂—; y is 1, 2, 3, 4, 5, 6, 7, 8, 9, or 10; and z is 0 or 1. In some embodiments, —C_{y}F_{y+2} is a straight chain alkyl. In some embodiments, —C_{y}F_{2y+1} is a branched alkyl, and y is equal to or more than 3. In some embodiments, R₁ and R₂ are identical. In some embodiments, R₂ and R₃ are identical. In some embodiments, R₁, R₂, and R₃ are identical.

In some embodiments, the electrolyte solvent is methoxyperfluorobutane, profluorinated alkane, bis(2,2,2-trifluoroethyl)ether, 1,1,2,2-tetrafluoroethyl-2′,2′,2′-trifluoroethyl ether, perfluorotributylamine, hydrofluoroether (HFE), or a mixture thereof. In some embodiments, the profluorinated alkane is C(H or F)₃[C(H or F)₂]ₓC(H or F)₃, wherein x is an integer from 0 to 20, and there are more F atoms than H atoms. In some embodiments, the profluorinated alkane is CF₃(CF₂)ₓCF₃, wherein x is an integer from 0 to 20. In some embodiments, x is 1, 2, 3, 4, 5, 6, 7, 8, 9, 10, 11, 12, 13, 14, 15, 16, 17, 18, 19, or 20. In some embodiments, the hydrofluoroether (HFE) is CHF₂CF₂—O—CH₂CF₂CHF₂, C₇F₁₅—O—C₂H₅, C₄F₉—O—C₂H₅, n-C₃F₇O—CH₃), CF₃CF₂—O—CH₃, CF₃CHFCF₂—O—CH₃, CF₃—O—CH₃, CHF₂—O—CHF₂, CF₃CF₂—O—CH₃), or CF₃—O—CHFCF₃. In some embodiments, the HFE is CHF₂CF₂—O—CH₂CF₂CHF₂.

In some embodiments, the electrolyte composition comprises one or more amphiphilic molecule of the present invention, or a mixture thereof; methoxyperfluorobutane, profluorinated alkane, bis(2,2,2-trifluoroethyl)ether, 1,1,2,2-tetrafluoroethyl-2′,2′,2′-trifluoroethyl ether, perfluorotributylamine, or a mixture thereof; and, LiTFSI, LiBOB, LiBETI, LiClO₄, LiFSI, LiPF₆, LiAsF₆, or a mixture thereof.

In some embodiments, the electrolyte composition comprises F₃EO₁:HFE=1:5 (v/v) and 0.5 M LiTFSI, wherein HFE is CHF₂CF₂—O—CH₂CF₂CHF₂. F₃EO₁ has the following chemical structure:

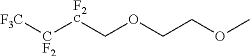 [SMILES: COCCOCC(F)(F)C(F)(F)C(F)(F)F]

In some embodiments, the electrolyte composition comprises F₈EO₄:HFE=2:3 (v/v) and 0.5 M LiTFSI, wherein HFE is CHF₂CF₂—O—CH₂CF₂CHF₂. F₈EO₄ has the following chemical structure:

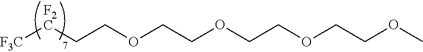

The shorthand labeling of biphiphilic additives FₙEOₘ is: “F” stands for the unit of —CF₂— and ending CF₃— moieties, and “n” is the number of the moieties; “EO” stands for the —CH₂CH₂O— ethyleneoxide moiety, the —CH₂ end is covalently bond with CF₂—, and the O— end is covalently bond with a methyl moiety, “m” is the number of the —CH₂CH₂O— repeating units. The “F” segment is profluorinated alkyl, and the “EO” segment is methyloligoethyleneoxide, wherein the two segments are linked by a covalent bond.

The present invention also provides for a lithium ion battery, or sodium ion battery, comprising the electrolyte composition of the invention.

The electrolyte composition of the present invention has more stability towards polysulfide, and promote polysulfide affiliation with the electrode substrate to prevent polysulfide dissolution.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows electrolyte ionic conductivities at 30° C.

FIG. 2 shows electrolyte ionic conductivities at variable temperatures. DOL/Hexane 60/40 mixed electrolytes has higher ionic conductivities than the reference electrolyte across a broad temperature range.

FIG. 3 shows over potential of lithium metal deposition on Cu surface. DOL/Hexane 60/40 mixed electrolytes lower over potential at the initial lithium deposition on Cu surfaces.

FIG. 4 shows repeated lithium deposition and stripping from Cu current collector. The current density is 1 mA/cm². The hydrocarbon mixed electrolytes give much stable performance.

FIG. 5 shows repeated lithium deposition and stripping from Cu current collector. The current density is 2 mA/cm². The hydrocarbon mixed electrolytes give stable performance even at higher current density.

FIG. 6 shows SEM surface images of the Li deposition on Cu current collector. Electrolyte Composition: 1M LiTFSI DOL-DME (50:50), Current Density: 0.1 mA/cm² for 20 h.

FIG. 7 shows SEM cross-section images of the Li deposition on Cu current collector. Li-deposition on Cu-foil 0.1 mA/cm² for 20 h DOL-DME 1M LiTFSI.

FIG. 8 shows the SEM surface images of the Li deposition on Cu current collector. Electrolyte Composition: 2.33 M LiTFSI DOL-n-Hexane (60:40), Current Density: 0.1 mA/cm² for 20 h.

FIG. 9 shows SEM cross-section images of the Li deposition on Cu current collector. Li-deposition on Cu-foil 0.1 mA/cm² for 20 h DOL-n-Hexane 2.33 M LiTFSI.

FIG. 10 shows SEM surface images of the Li deposition on Cu current collector. SEM surface images of the Li deposition on Cu current collector. Electrolyte Composition: 1M LiTFSI DOL-DME (50:50). Current Density: 1 mA/cm² for 2 h.

FIG. 11 shows SEM surface images of the Li deposition on Cu current collector. Electrolyte Composition: 2.33 M LiTFSI DOL-n-Hexane (60:40). Current Density: 1 mA/cm² for 2 h.

FIG. 12 shows LiS battery performance with hydrocarbon based electrolytes.

FIG. 13 shows LiS battery performance with hydrocarbon based electrolytes.

FIG. 14 shows LiS battery performance with hydrocarbon based electrolytes. (a) Li-Anode after 122 cycles. Electrolyte solution: DOL:DME (1:1) 1M LiTFSI. (b) Li-Anode after 115 cycles. Electrolyte solution: DOL:n-Hexane (0.6:0.4) 2.33M LiTFSI.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

As used in the specification and the appended claims, the singular forms “a,” “an,” and “the” include plural referents unless the context clearly dictates otherwise. Thus, for example, reference to “molecules” includes a plurality of a molecule species as well as a plurality of molecules of different species.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The term “about” refers to a value including 10% more than the stated value and 10% less than the stated value.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

Notably, studies have revealed that using LiFSI salt in 1,3-dioxolane (DOL)/dimethyl ether (DME) solvent can yield a large initial capacity. This outcome is attributed to LiFSI's stronger affinity toward polysulfides and electrode surfaces. However, the rapid diffusion of polysulfides, due to the low viscosity of the electrolyte, can compromise cycle stability. Conversely, increasing the LiFSI concentration exacerbates cycle performance degradation. In contrast, electrolytes with concentrated LiTFSI exhibit good stability, offering a promising avenue for addressing these challenges. This phenomenon arises because the N—S bond in the FSI anion is relatively weak, facilitating its breakage and reaction with Li₂Sₓ to produce lithium sulfate (LiSOₓ). Conversely, when a LiTFSI-based electrolyte is employed, lithium sulfide (Li₂Sₓ) is formed on the lithium metal anode. Importantly, the Li₂Sₓ formed in LiTFSI-based electrolytes exhibits greater reversibility compared to the LiSOₓ generated in LiFSI-based electrolytes.

In the realm of LSBs, the choice of electrolyte solvent plays a crucial role in determining performance outcomes. While carbonate and sulfone-based electrolytes are common, ether-based solvents like tetrahydrofuran (THF), DOL, DME, and tetra(ethylene glycol) dimethyl ether (TEGDME) offer enhanced chemical and electrochemical stability. However, solubility issues arise with DOL for Li₂Sₓ, hampering reaction kinetics improvement. Conversely, linear DME exhibits excellent solvation capabilities for Li₂Sₓ, yet it tends to react strongly with Li metal. A blend of DOL and DME emerges as a promising solution, leveraging synergistic effects to enhance specific capacity and retention of sulfur cathodes, a well-established combination in LSBs.

Recent exploration extends to binary electrolytes like TEGDME/DOL, revealing nuanced impacts of solvent type, lithium salt concentration, and additives on electrochemical performance. Notably, the solvation capacity of the electrolyte emerges as a critical factor, with weaker solvation abilities and excessive DOL leading to polymerization limitations.

Additionally, hexyl methyl ether (HME) presents an alternative blend with DOL, mitigating Li₂Sₓ dissolution and the shuttle effect through reduced solubility. Contrastingly, fluoroether-based solvents, featuring strong electronegativity and weak polarity due to fluorine's unique properties, offer intriguing prospects.

Fluorinated solvents like 1,1,2,2-tetrafluoroethyl-2,2,3,3-tetrafluoropropyl ether (TTE) exhibit potential in preventing the Li₂Sₓ shuttle effect, enhancing Coulombic efficiency, and facilitating capacity retention. The formation of a stable solid electrolyte interface (SEI) layer further augments battery performance.

Moreover, partially fluorinated structures like 1,1,2,2-tetrafluoroethyl 2,2,2-trifluoroethyl ether (TFTFE) and bis(2,2,2-trifluoroethyl) ether (BTFE) show promise in boosting reversible capacity, Coulombic efficiency, and minimizing self-discharge losses.

The other side of the issue is the lithium metal electrode. The lithium metal deposition in the traditional ether-based electrolyte is more stable than in the carbonate-based electrolyte. However, forming both dendritic and mossy lithium the during extended period of electrochemical deposition is a common failure mode in any of the existing electrolyte. Although highly fluorinated local highly concentrated electrolyte demonstrated improved lithium metal cycling performance, the lower conductivity compared to the state of art electrolyte limits the application of the electrolyte. Highly fluorinated organics also raise environmental concerns due to the generation of PFAS materials both during production, and applications.

Addressing these hurdles calls for focused research on designing highly conductive electrolyte solutions capable of minimizing polysulfide dissolution and ensuring stability against Li-metal, pivotal for realizing high-performance LSBs.

In some embodiments, the present invention can be used in a high voltage lithium ion and lithium metal battery, or a high voltage sodium ion and sodium metal battery. In some embodiments, the anode comprises lithium or sodium metal. In some embodiments, the battery is a coin cell. In some embodiments, the battery has an operational voltage 2.75V-4.4V.

The electrolytes can be used for high voltage lithium metal cells. In some embodiments, the cathode is an NMC material (such as (111, 532, 622 or 811)), NCA materials (such as LiNi_{0.8}Co_{0.15}Al_{0.05}O₂), or Nickelate material (such as LiNiO₂). In some embodiments, the cell voltage can range from 2.5 V to 6 V. In some embodiments, the anode is a Cu, Ni, or Ti, Lithium metal; a Si based material (such as Si, Si/C, SiOx), carbon base materials (such as graphite), or a mixture thereof (such as a mixture of Si based materials and carbon based materials). In some embodiments, the electrolyte is any combination of the alkane, and electrolyte compositions disclosed herein.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

The invention having been described, the following examples are offered to illustrate the subject invention by way of illustration, not by way of limitation.

### Example 1

A mixed solvent electrolyte based on the dispersion of the electrolyte in hydrocarbon solvents was prepared. It has been long understood that the hydrocarbon without any organic functional groups are the most stable organic compounds toward alkaline metals. In fact, it is a long practice to store the Na and K metals are stored in the kerosene. Low molecular weight hydrocarbon, such as hexane also has low viscosity. Moreover, the polysulfides has low solubility in hydrocarbon solvents, therefore mixing of common lithium salt organic electrolytes with hydrocarbon solvents such as hexane and isomers can slow down the lithium metal to electrolyte reactivity, and prevent polysulfides dissolution.

The chemicals mentioned, such as 1,3 dioxolane (DOL), n-hexane, cyclohexane, 2,3 dimethylbutane, dimethoxy ethane (DME), bis(trifluoromethane)sulfonamide lithium (LiTFSI), poly(vinylidenefluoride) (PVDF, Mw=˜534000), 1-methyl-2-pyrrolidinone (NMP), sulfur, denka black, and ketjen carbon black, were sourced from Sigma Aldrich (Burlington, MA). These substances were utilized in their original form without any additional purification steps. The Li-metal disk, Cu-foil, and polypropylene separator were provided by Albemarle Corp. (Charlotte, NC) and Celgard, LLC (Charlotte, NC) respectively, and were stored within the glove box.

The electrodes' surface characteristics, elemental compositions, and topographies were examined using scanning electron microscopy (SEM, JEOL JSM-750F). Following the completion of electrochemical experiments, the electrode underwent a gentle rinse with a few drops of anhydrous DOL and was subsequently dried in the antechamber overnight. It was then securely attached to an SEM sample stage using conductive carbon tape after the drying process. The SEM stage, along with the samples, was positioned within a Teflon box, tightly sealed with parafilm. The glove box maintained a pressure greater than ambient pressure, ensuring that air did not infiltrate the sealed box. When removed from the glove box, the SEM stage was swiftly transferred to the SEM chamber within about 5 seconds to minimize exposure to air.

Additionally, X-ray photoelectron spectroscopy (XPS) was employed for a more in-depth analysis of the electrodes. For the XPS analyses, an air-free sample holder, featuring Ag-tape on a Si-substrate, was placed within an argon-filled glove box. The electrodes were securely affixed using the Ag-tape. The XPS experiment was carried out using a Thermo-Fisher K-Alpha Plus XPS/UPS analyzer with a monochromatic Al Kα X-rays (1.486 eV) source at The Molecular Foundry (Lawrence Berkeley National Laboratory, Berkeley, CA), operating at a pressure of 2.0×10⁻⁷ Pa.

The measurement of ionic conductivity (σ) was undertaken using a high-temperature conductivity cell (HTCC), a sealed 2-pole cell featuring two platinum electrodes and a cell constant of 1 cm⁻¹. The σ value was determined using the formula σ=K/R, where K is the cell constant, and R is the resistance of the electrolyte. In the electrochemical impedance spectroscopy (EIS) analysis, 0.6 mL of the electrolyte solution was employed. The EIS experiments were executed with an impedance analyzer from Biologic (Claix, France) over a temperature range of −20° C. to 60° C. Measurements involved applying an alternating current (AC) amplitude of 5 mV across a frequency range spanning from 1 MHz to 100 mHz. The electrochemical stability of the electrolyte solutions was examined through a linear sweep voltammetry (LSV) test. This test was performed using a VMP3 potentiostat from BioLogic, employing a coin-cell configuration of Li metal//electrolyte//sulfur/carbon (S/C) composite, where CELGARD® (Charlotte, NC) served as the separator. The LSV test was conducted at a scan rate of 0.1 mV/s, and the temperature was maintained at 30° C.

For the preparation of electrolyte solutions, a combination of DOL, DME, n-Hexane, cyclohexane, 2,3-dimethyl butane, and LiTFSI salt was utilized. These solutions are identified as DDLiTFSI, DnH40LiTFSI, DcH40LiTFSI, DDMB40LiTFSI, DnH43LiTFSI, DcH43LiTFSI, and DDMB43LiTFSI, respectively. All electrolyte solutions were prepared and stored in the Ar-filled glove box (O₂<0.1 ppm, H₂O<0.1 ppm). The detailed composition of the electrolyte solutions can be found in Table 1.

TABLE 1
Compositions of the Prepared Electrolyte Solutions

| Acronym | Ratio of the solvent (vol %) | | | | | |
|---|---|---|---|---|---|---|
| of the | | | | | 2,3- | LiTFSI Salt |
| electrolyte | | | n- | cyclo- | dimethyl | concentration, |
| solution | DOL | DME | hexane | hexane | butane | molar (M) |
| DDLiTFSI | 50 | 50 | — | — | — | 1 |
| DnH40LiTFSI | 60 | — | 40 | — | — | 2.33 |
| DcH40LiTFSI | 60 | — | — | 40 | — | 1.97 |
| DDMB40LiTFSI | 60 | — | — | — | 40 | 1.33 |
| DnH43LiTFSI | 57 | — | 43 | — | — | 0.83 |
| DcH43LiTFSI | 57 | — | — | 43 | — | 0.83 |
| DDMB43LiTFSI | 57 | — | — | — | 43 | 0.83 |

Furthermore, the S/C composite electrode was prepared following our prior methodology. Initially, ketjen carbon black and sulfur (S) were mixed in a 3:7 (wt %) ratio using a Cryo Mill mechanical ball mixer for a duration of 20 minutes. Subsequently, the resulting mixture underwent annealing at about 150° C. to 155° C. for 20 hours in a furnace within a Teflon container to generate the S/C composite.

For the electrode slurry preparation, a combination of S/C composite, denka black, and PVDF binder was employed in a weight ratio of 6:3:1. This mixture was then combined with 10 wt % NMP solvent, and a pestle and mortar were utilized for thorough slurry mixing. The electrode slurry was doctor-bladed onto an aluminum foil current collector (20 μm) and dried overnight at 40° C. The resulting S/C composite cathode disk, with an additional 20-hour vacuum drying, was transferred into an argon-filled glove box.

In Li∥Cu CR2032-type coin cells, the working electrode was composed of a 10 μm thick Cu foil (Canrd, 99%) with a diameter of 12 mm. Simultaneously, the counter/reference electrode was a 10 mm diameter Li foil. This design aimed to mitigate mass transport limitations at high current densities required to surpass SEI formation. The Cu foil underwent rinsing with ultrapure water and acetone to eliminate surface contaminants before being transferred into the glove box.

The Li foil underwent mechanical shearing using a polyethylene scraper to remove surface oxide, enhancing electrical connection to the stainless steel coin cell case. Each cell received 60 μL of electrolyte, and a CELGARD® separator was used to separate the two electrodes. Subsequently, the coin cells were loaded onto a battery tester and subjected to cycling.

The construction of symmetric Li//Li CR2032-type coin cells mirrored the procedure for Li//Cu cells, with the only difference being the utilization of two polished and flattened 1 cm² disks of Li foils. These discs served as both the working and counter electrodes in the assembly.

Assembly of CR2032 coin cells involved using the S/C cathode disk (diameter 12.7 mm; 1.40 mg/cm² S loading), Li-metal anode disk (diameter 14 mm), an appropriate amount of the prepared electrolyte solution, and a CELGARD® separator (diameter 18 mm). The coin cells' capacity was tested using a Maccor series 4000 cell tester at voltages of 1.7 and 2.8 V (at 0.1C rate) at 30° C.

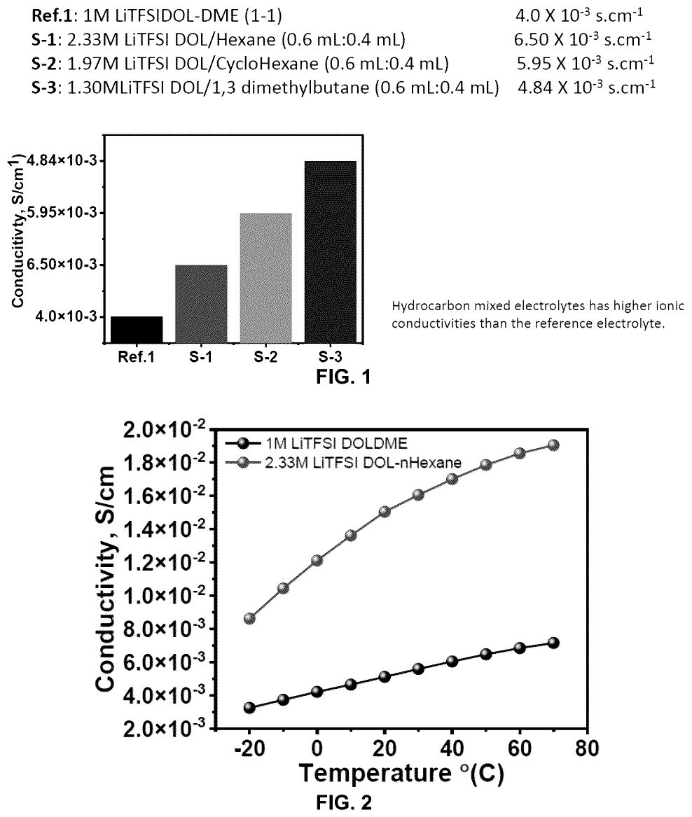

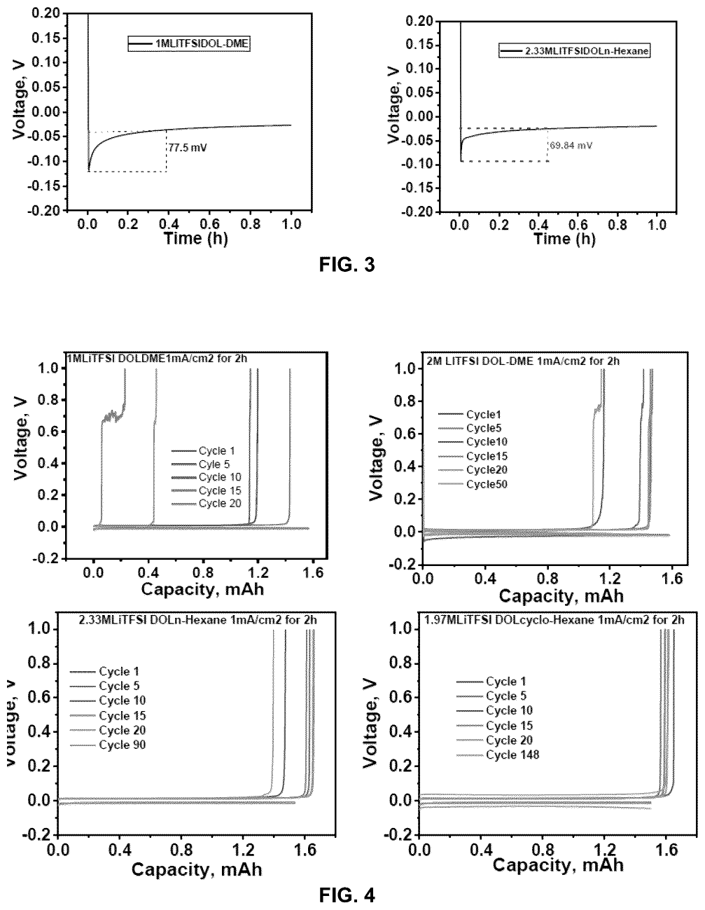

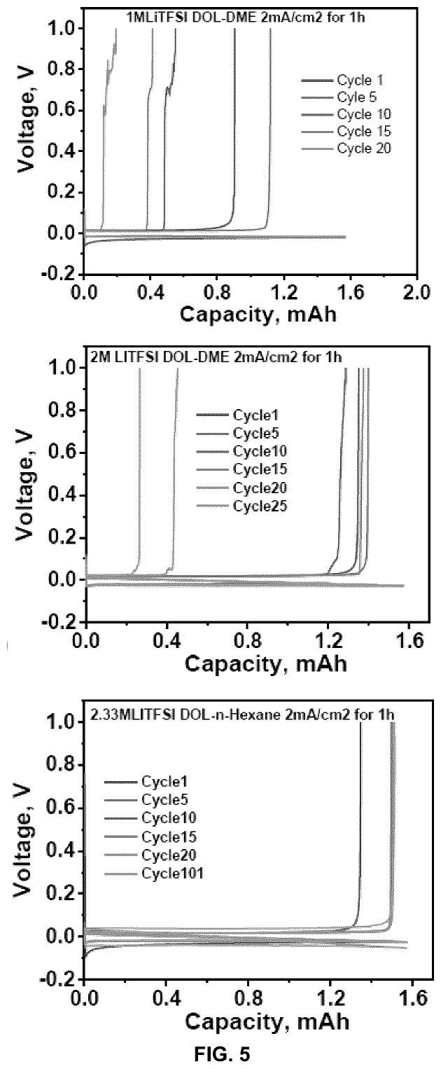

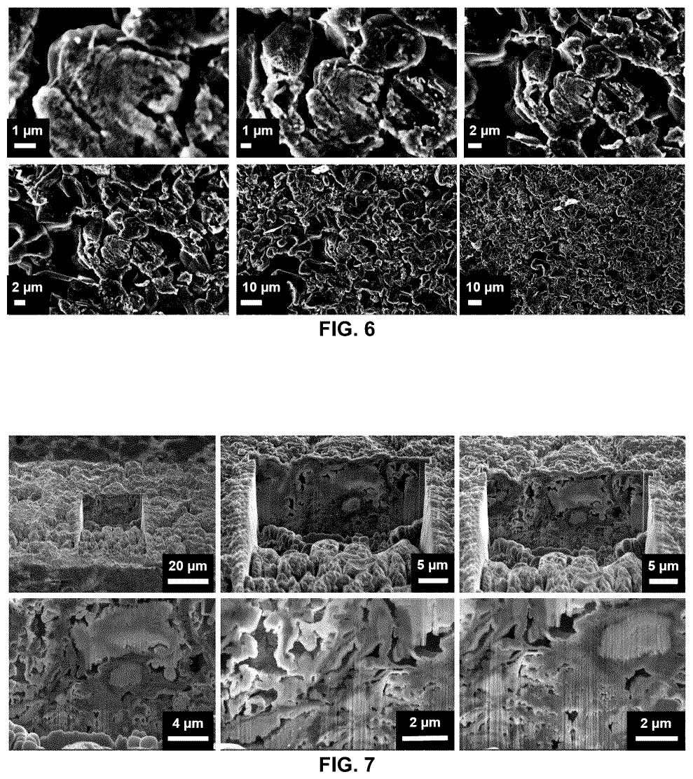

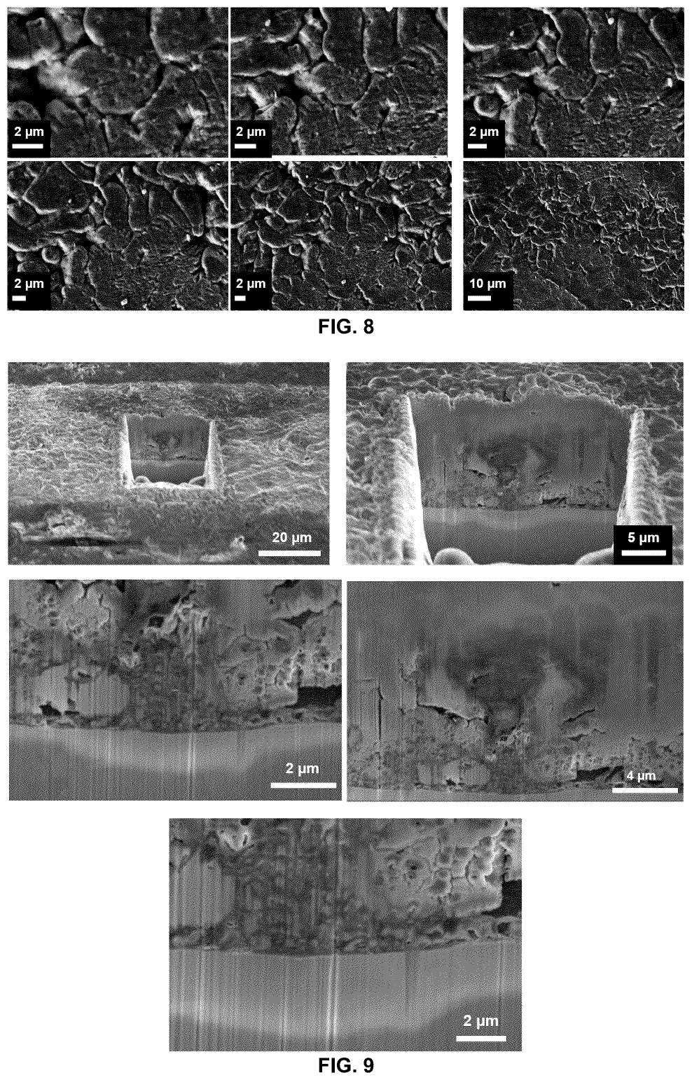

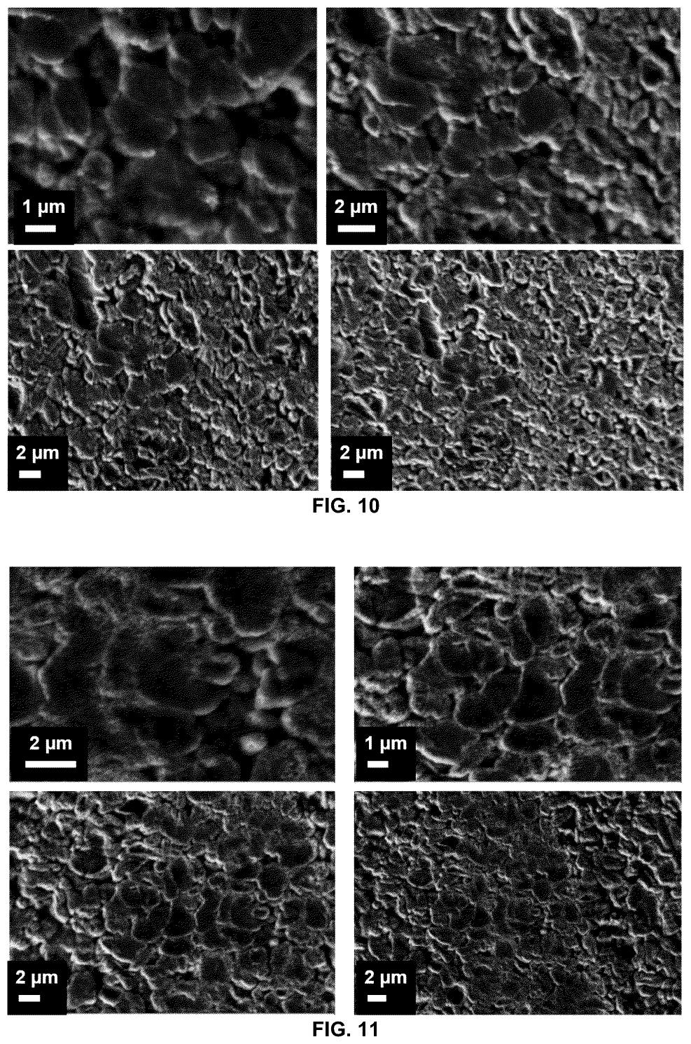

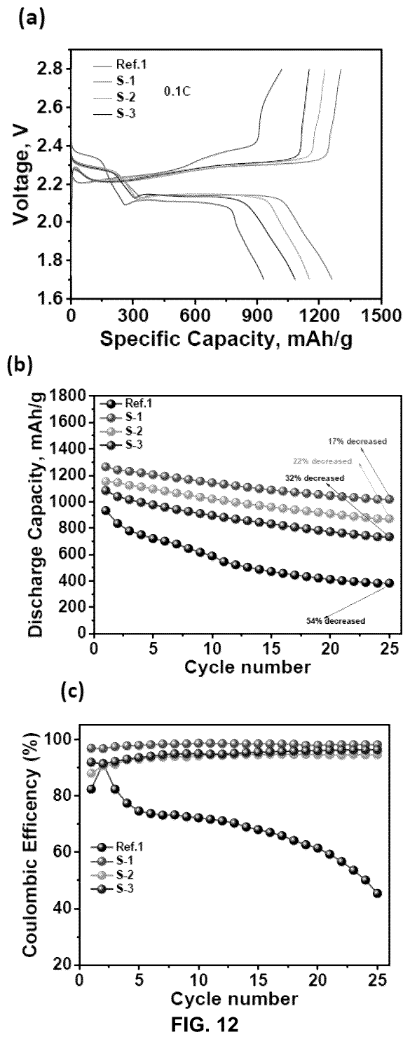

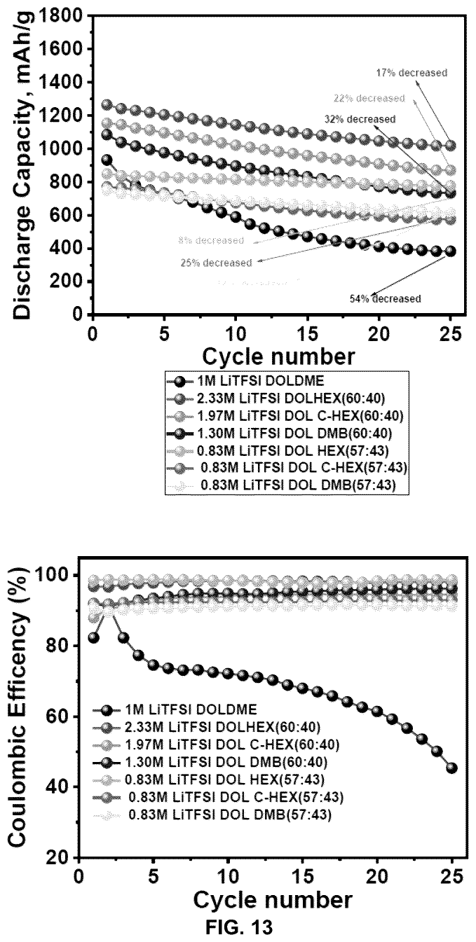

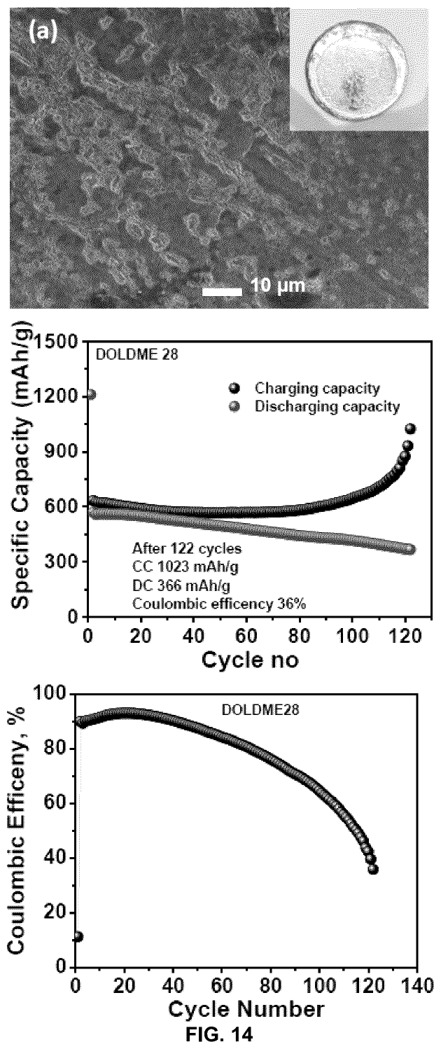

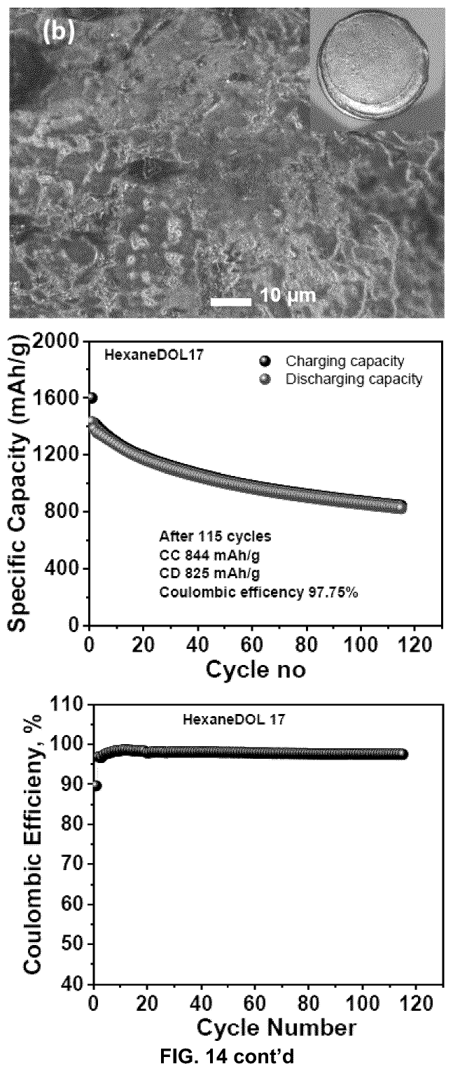

Results are shown in FIGS. 1-14.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

All cited references are hereby each specifically incorporated by reference in their entireties.

What is claimed is:

1. An electrolyte composition comprising a hydrocarbon solvent.

2. The electrolyte composition of claim 1, wherein the hydrocarbon solvent is an alkane.

3. The electrolyte composition of claim 2, wherein the hydrocarbon solvent is a 2, 3, 4, 5, 6, 7, 8, 9, or 10 carbon alkane, or a mixture thereof.

4. The electrolyte composition of claim 3, wherein the hydrocarbon solvent is a 5 to 7 carbon alkane, or a mixture thereof.

5. The electrolyte composition of claim 3, wherein the hydrocarbon solvent is a branched or straight chained alkane, or a mixture thereof.

6. The electrolyte composition of claim 3, wherein the hydrocarbon solvent is a cyclic alkane.

7. The electrolyte composition of claim 4, wherein the hydrocarbon solvent is n-heptane, n-hexane, n-pentane, cyclohexane, cyclopentane, cycloheptane, or isomer thereof, or a mixture thereof.

8. The electrolyte composition of claim 1, wherein further comprising an ether solvent, an amphiphilic molecule, an electrolyte solvent, and a lithium or sodium salt.

9. The electrolyte composition of claim 8, wherein the ether solvent comprises an ether solvent molecule comprising an ether functional group, a carbonate functional group, or an ester functional group, or any mixture thereof.

10. The electrolyte composition of claim 8, wherein the ether solvent molecule is linear or cyclic.

11. The electrolyte composition of claim 8, wherein the ether solvent molecule comprises a plurality of ether functional groups, carbonate functional groups, or ester functional groups, or any mixture thereof.

12. The electrolyte composition of claim 8, wherein the ether solvent molecule is a polymer.

13. The electrolyte composition of claim 8, wherein the ether solvent molecule is a dimethyl ether, ethyl methyl ether, diethyl ether, dipropyl ether, diisopropyl ether, divinyl ether, 1,2-dimethoxyethane ether, methyl phenyl ether (anisole), cyclopropyl methyl ether, diphenyl ether, furan, tetrahydrofuran (THF), 1,4-dioxane, or a mixture thereof.

14. The electrolyte composition of claim 8, wherein the ether solvent molecule is a 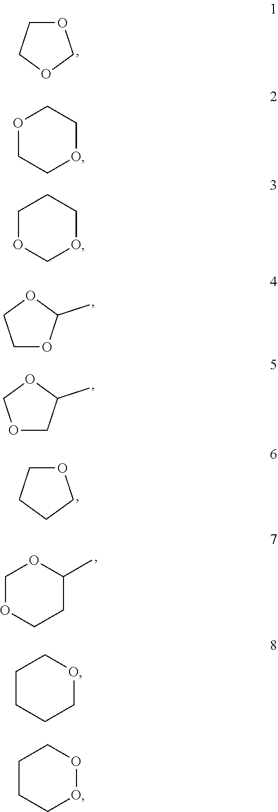
or a mixture thereof.

15. The electrolyte composition of claim 8, wherein the ether solvent molecule is a 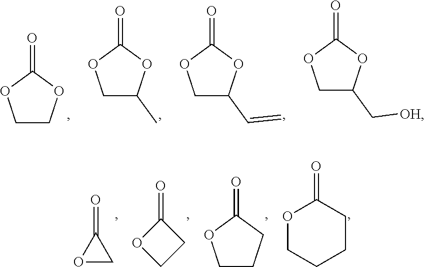
or a mixture thereof.

16. The electrolyte composition of claim 8, wherein ether solvent molecule is dioxolane (DOL), dimethyl ether (DME), glyme, diglyme, triglyme, tetraglyme, ethylene carbonate (EC), diethyl carbonate (DEC), ethyl methyl carbonate (EMC), dimethyl carbonate (DMC), propylene carbonate (PC), or a mixture thereof.

17. The electrolyte composition of claim 8, wherein the amphiphilic molecule has the following structure: 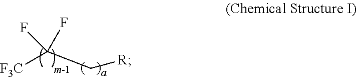
wherein R is 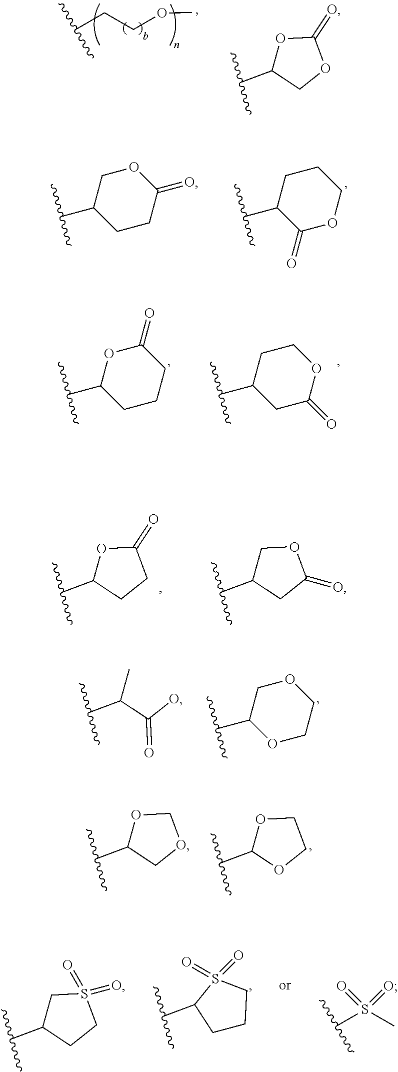
m is an integer from 1 to 21; a is an integer from 0 to 20; b is an integer from 0 to 4; n is an integer from 1 to 20; and m is an integer from 1 to 20.

18. The electrolyte composition of claim 17, wherein the amphiphilic molecule has the following structure: 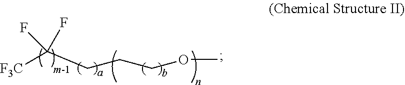
wherein m is an integer from 1 to 21, a is an integer from 0 to 20, b is an integer from 0 to 4, and n is an integer from 1 to 20.

19. The electrolyte composition of claim 18, wherein the amphiphilic molecule has the following structure: 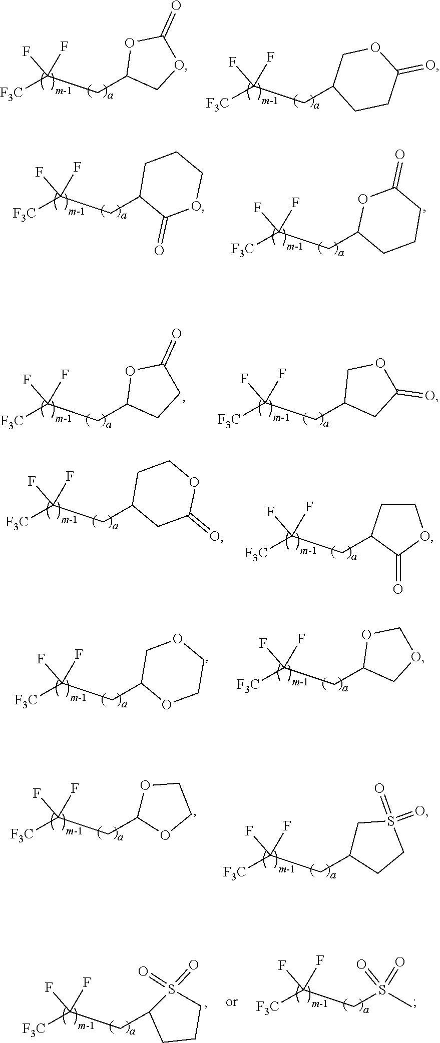
wherein m is an integer from 1 to 21; a is an integer from 0 to 20.

20. The electrolyte composition of claim 8, wherein the amphiphilic molecule is capable of self-formation of a micelle.

21. The electrolyte composition of claim 8, wherein the electrolyte solvent has the following chemical structure: R₁—O—R₂, or 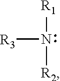
wherein R₁ is —CH₃, —C₂H₅, or —R₄; and R₂, R₃, and R₄ are each independently -α-C_{y}H_{z}F_{2y+1-z}, wherein α is −, —CHF—, —CF₂—, or —CH₂—; y is 1, 2, 3, 4, 5, 6, 7, 8, 9, or 10; and z is 0 or 1.

22. The electrolyte composition of claim 21, wherein the electrolyte solvent is a methoxyperfluorobutane, profluorinated alkane, bis(2,2,2-trifluoroethyl)ether, 1,1,2,2-tetrafluoroethyl-2′,2′,2′-trifluoroethyl ether, perfluorotributylamine, hydrofluoroether (HFE), or a mixture thereof.

23. The electrolyte composition of claim 22, wherein the electrolyte solvent is a profluorinated alkane, and the profluorinated alkane is CF₃(CF₂)ₓCF₃, wherein x is an integer from 0 to 20.

24. The electrolyte composition of claim 22, wherein the electrolyte solvent is a HFE, and the HFE is CHF₂CF₂—O—CH₂CF₂CHF₂, C₇F₁₅—O—C₂H₅, C₄F₉—O—C₂H₅, n-C₃F₇O—CH₃), CF₃CF₂—O—CH₃, CF₃CHFCF₂—O—CH₃, CF₃—O—CH₃, CHF₂—O—CHF₂, CF₃CF₂—O—CH₃), or CF₃—O—CHFCF₃.

25. The electrolyte composition of claim 8, wherein the lithium salt is a lithium bis(trifluoromethanesulfonyl)imide (LiTFSI), lithium bis(oxalato)borate (LiBOB), lithium bis(pentafluoroethanesulfonyl)imide (LiBETI), LiClO₄, lithium bis(fluorosulfonyl)imide (LiFSI), LiPF₆, LiAsF₆, or a mixture thereof.

26. The electrolyte composition of claim 25, wherein the lithium salt has an ionic association strength that is equal to or less than about the ionic association strength of LiBETI, and is equal to or more than about the ionic association strength of LiTFSI.

27. The electrolyte composition of claim 8, wherein the sodium salt is a sodium bis(trifluoromethanesulfonyl)imide (NaTFSI), sodium bis(oxalato)borate (NaBOB), sodium bis(pentafluoroethanesulfonyl)imide (NaBETI), LiClO₄, sodium bis(fluorosulfonyl)imide (NaFSI), NaPF₆, NaAsF₆, or a mixture thereof.

28. An ion battery comprising the electrolyte composition of claim 1, wherein (a) the ion battery is a lithium ion battery and the electrolyte composition comprises a lithium salt, or (b) the ion battery is a sodium ion battery and the electrolyte composition comprises a sodium salt.
